(19) United States
(12) Patent Application Publication
(10) Pub. No.: US 2017/0267313 A1
(43) Pub. Date: Sep. 21, 2017

(54) METHOD AND DEVICE FOR PREVENTING A FALL OF A BICYCLIST

(71) Applicant: Robert Bosch GmbH, Stuttgart (DE)

(72) Inventors: Christoph Schumacher, Dusslingen (DE); Johannes Alex Gerstenkorn Lavall, Reutlingen (DE)

(73) Assignee: Robert Bosch GmbH, Stuttgart (DE)

(21) Appl. No.: 15/504,960

(22) PCT Filed: Jun. 23, 2015
(86) PCT No.: PCT/EP2015/064034

§ 371 Date: Feb. 17, 2017

(30) Foreign Application Priority Data
Aug. 21, 2014 (DE) 102014216671.3

(51) Int. Cl. B62M 6/50

(52) U.S. Cl. CPC B62M 6/50

(57) ABSTRACT

A method as well as a device are described for use in a two-wheeler, in particular in an at least partially electrically drivable bicycle. In this context, the lift-off of at least one wheel is initially detected and a jump is inferred therefrom, possibly while utilizing further sensor signals. Then the risk is calculated that this jump may cause a rollover, e.g., over the handlebars or in the backward direction. In the event that this is the case, the at least one lifting-off wheel is acted upon in such a way that a counter torque is generated that counteracts the rotary motion leading to the rollover.

### FIELD OF THE INVENTION

The present invention relates to a method and a device for detecting a fall in the case of a two-wheeler and for initiating countermeasures.

### BACKGROUND INFORMATION

While riding a two-wheeler traffic situations may arise in which the rear wheel leaves the ground. For example, braking abruptly solely with the aid of the front-wheel brake of a bicycle entails the risk that the driver will flip over the handlebars. In addition, however, shifts in weight may also occur during more or less intentional jumps such as over curbstones, which result in a forward- or backward-directed roll-over. Especially at risk are bicyclists who are riding mountain bikes across open terrain.

To detect a roll-over or flip-over of a vehicle, it is known from German Published Patent Application No. 102 42 687 A1, for example, to equip this vehicle with various sensors. For instance, a rotary motion of the vehicle is able to be detected by sensing the air pressure at two sensors that feature a vertical difference.

In addition, however, it is also known to sense rotary motions of the vertical axis of vehicles, for instance within the framework of an ESP system, utilizing a yaw-rate and/or acceleration sensor.

### SUMMARY

The present invention pertains to a method and a device for use in a two-wheeler, in particular in an at least partially electrically drivable bicycle. In this case, it is first detected that at least one wheel has left the ground and a jump is inferred on that basis, possibly utilizing additional sensor signals in so doing. Then, the risk is calculated that a roll-over, such as over the handlebars or in the backward direction, may occur in the course of this jump. In the event that this is the case, the at least one wheel lifting off is acted upon in such a way that a counter torque is generated that counteracts the rotary motion leading to the roll-over.

The generation of the counter torque makes it possible to prevent a fall or at least reduce its consequences in a timely manner with the aid of the components installed on the bicycle.

For example, the counter torque can be produced by actuating an electric drive, which generates a rotary motion on the wheel that is losing contact with the ground. The direction of this rotary motion is a function of whether a roll-over over the handlebar or a fall in the supine position in the backward direction is predicted. For example, in the case of a detected roll-over over the handlebar, an acceleration pulse is transmitted to the drive in order to stabilize the two-wheeler, or in other words, to compensate for the rotary motion of the two-wheeler or to reduce it.

As an alternative, it may also be provided that the already existing drive of the wheel that has lost contact with the ground is reduced or switched off in order to thereby achieve a braking effect. This process reduces the torque that is still present during the jump, and thus also reduces the rotation of the two-wheeler.

However, if the two-wheeler is not equipped with a drive or if this drive is not available or is not to be used, it is also possible to activate a braking device on the wheel that is losing contact with the ground in order to compensate for the rotary motion so that the torque that produces and/or contributes to the rotary motion of the two-wheeler is reduced or eliminated.

In an advantageous manner, the jump, the lift-off of the at least one wheel and/or the roll-over tendency or roll-over risk are/is detected with the aid of the at least one sensor mounted on the two-wheeler. For example, a rotation of the two-wheeler about its pitch axis is able to be detected with the aid of an acceleration sensor, a pressure sensor, a tilt sensor and/or a position sensor or a yaw-rate sensor. In addition, it is also possible to use two sensor signals for a more rapid and precise detection of the jump or the lift-off or the roll-over tendency. Furthermore, the detection of the jump or the lift-off and the roll-over tendency may also be carried out with the aid of different sensors.

In addition, it may be provided that the counter torque for the wheel that is losing contact with the ground is generated only if the roll-over tendency or the rotation of the two-wheeler about the pitch axis exceeds a specific threshold value. The roll-over tendency or the rotation may be detected in the form of an acceleration, a yaw rate and/or a critical tilt or tilt change. The threshold value may be set in such a way that a fall must be assumed starting with this value, e.g., in that a critical tilt has been exceeded or it cannot be assumed that the rotary motion will be fully executed prior to a roll-over in the forward or backward direction. Of course, it is also possible to use this threshold value to reduce or eliminate the torque of the wheel lifting off that contributes to the rotation and thus the roll-over tendency, to below this value.

The present method or the present device is advantageously used for a bicycle that is at least partially able to be driven electrically. In this context it is provided in particular that the drive of the bicycle acts on the rear wheel so that the torque of the rear wheel is increased in case of a jump and/or the torque is also reduced or eliminated when utilizing a braking effect. The additional generation of the torque or the increase in the torque allows for the generation of an angular momentum at the rear wheel that counteracts the rotation of the bicycle about the pitch axis and thus reduces the risk of a fall caused by the forward or backward roll-over.

### BRIEF DESCRIPTION OF THE DRAWING

FIGS. 1a through 1c illustrate different possible situations during a jump with a two-wheeler in the form of a bicycle.

FIG. 2 shows a specific embodiment of the device according to the present invention in the form of a block diagram.

FIG. 3 shows a flow diagram corresponding to a specific embodiment of the method of the present invention.

### DETAILED DESCRIPTION

In the following exemplary embodiments, the present invention is described when used on a bicycle, in particular a bicycle equipped with an electric drive. This electric drive is to act on the rear wheel in the following embodiments, but an effect on the front wheel is readily conceivable as well. In addition, it should be pointed out, however, that the present invention may also be used in a similar manner on any other two-wheeler in which a drive means is able to generate a torque on one of the wheels or in which a brake device can reduce or eliminate the torque on one of the wheels.

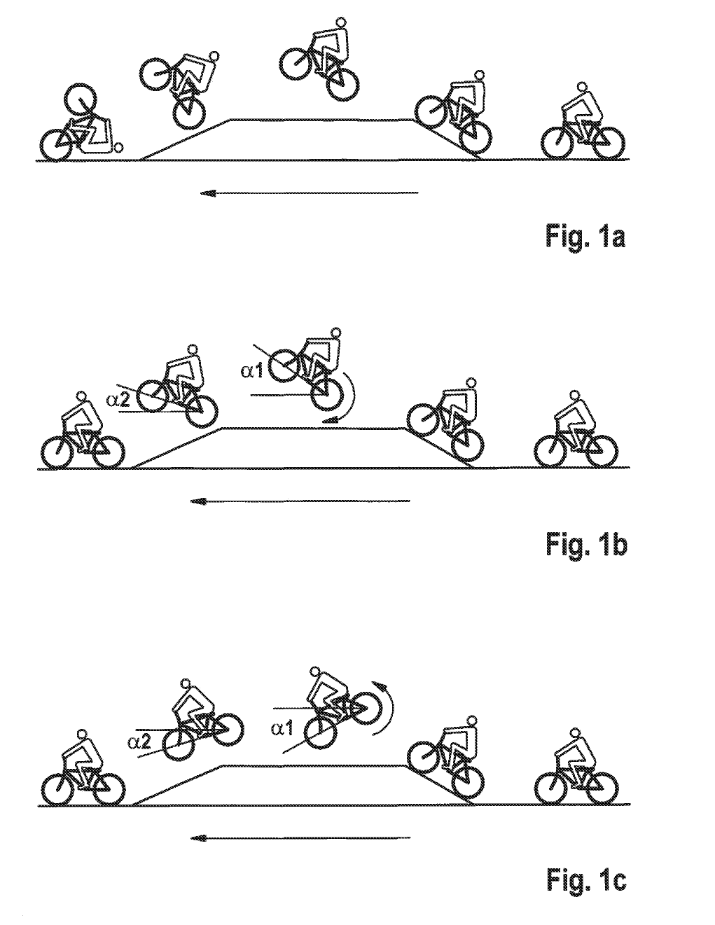

FIG. 1a shows an exemplary driving situation of a bicyclist during a jump over a ramp. Such situations may arise at a curbstone or, in a variation, during downhill driving, for instance. As can be gathered from FIG. 1a, a rotary motion may be generated during a jump, which would cause the driver to tilt backward and fall. This backward roll-over may be made even worse by an unfavorable weight distribution on the bicycle, for instance on account of the presence of bags or some other weight on the pack rack. The bicyclist may therefore also tip over in the forward direction and execute a roll-over over the handlebars, in particular when the rider is leaning forward.

As illustrated with the aid of FIG. 1b, the method according to the present invention initially detects that a jump has occurred. In this illustrated example, both wheels have lost contact with the ground so that the bicycle is at least partially in free flight in the air. However, it is also possible that only one wheel lifts off from the ground surface. The detection of the jump presupposes that at least one wheel lifts off and a rotary motion about the pitch axis in the bicycle center or on the front wheel is generated in this way. If suitable sensors now detect that this rotary motion will result in the driver of the bicycle no longer being able to land safely, or if they indicate that a roll-over toward the rear (FIG. 1b) or toward the front (FIG. 1c) is to be expected, then countermeasures are initiated. In the case of the roll-over tendency toward the rear, as in FIG. 1b, it is possible to brake the wheel that is still rotating after the lift-off in an effort to thereby reduce or completely eliminate the still existing torque of the rear wheel that has lost contact with the ground. This also reduces the rotary motion of the entire bicycle. In FIG. 1b, this reduces the excessive angle α1 to be expected between the ground surface and the longitudinal axis of the vehicle to a measure α2, which allows for a safe landing without a fall. Furthermore, however, it is also possible to control the airborne wheel with the aid of a drive so that a counter torque is generated which reduces the rotary motion of the bicycle or compensates for it.

Accordingly, FIG. 1c illustrates the situation in which the driver or the bicycle exhibits a roll-over tendency in the forward direction during the jump. For example, this may happen as a result of a disadvantageous weight shift of the driver during the jump or it may also be due to the ground conditions of the jump. Because of this forward-directed roll-over tendency, there is the risk that the driver will execute a roll-over over the handlebars and thus will fall, since expected angle α1 during landing is greater than angle α2 that is just barely still safe for landing. By activating the drive of the bicycle in such a case and by the drive acting on the rear wheel such that a torque is generated there, which acts counter to the rotary motion of the bicycle, the alignment of the bicycle is able to be compensated in this case too and a fall can therefore be prevented.

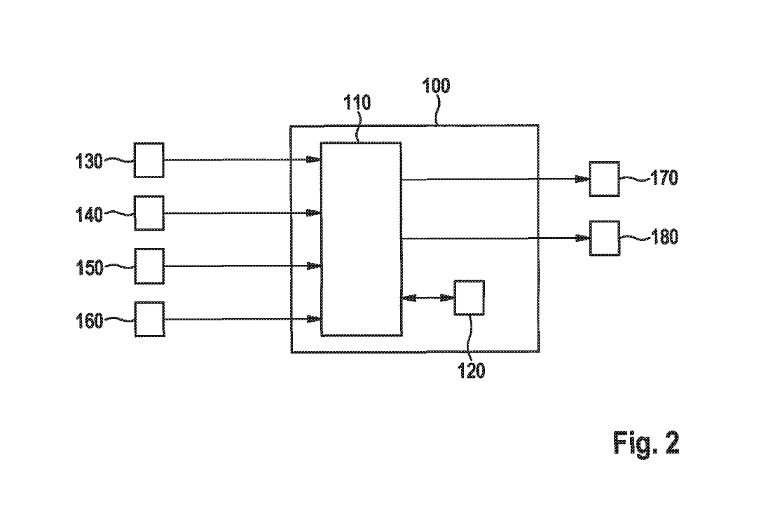

FIG. 2 shows a device 100 according to the present invention, which generates the aforementioned compensation of the rotary motion and thus provides a roll-over prevention. The device includes a processing device 110 and a memory 120, which is linked thereto and stores threshold values for critical rotary motions, for example. These threshold values can be permanently stored and/or they are able to be applied by the driver. Processing unit 110 reads in at least the sensor signals from a sensor installed on the bicycle in order to thereby detect the lift-off of the bicycle and/or the rotary motion, i.e. a critical rotary motion. Suitable in this context are the sensor signals from an acceleration sensor 130, a rotational frequency sensor 140, a tilt sensor or position sensor 150, for instance, or some other suitable sensor 160 such as one or more pressure sensor(s), an ultrasonic sensor or a distance sensor. Based on the acquired sensor signals and a detected rotary motion that could lead to a roll-over or to a fall, motor 170 and/or a brake device 180 of the vehicle are/is actuated in order to influence the rotary motion of the entire bicycle. As already explained previously, this may be achieved by the generation of a compensating counter torque by the motor, for instance.

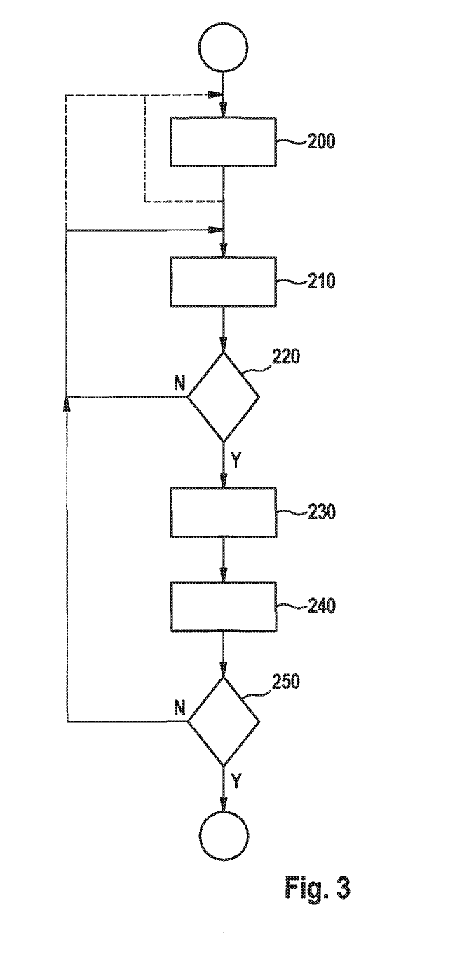

A possible method for detecting the risk of a roll-over and for avoiding a fall according to the present invention such as it may also be carried out in a device 100 according to FIG. 2 is described in the following text with the aid of the flow diagram of FIG. 3. The method or the algorithm may be permanently active or be started in response to the detection of a jump, e.g. by detecting the lift-off of a wheel, such as in step 200. After the start of the algorithm, a jump of the bicycle is detected in step 200, for instance in that an acceleration sensor, a position/tilt/state sensor, an ultrasonic sensor or also a pressure sensor detects the lift-off of at least one wheel, possibly through a comparison with another sensor signal. In the event that no lift-off is detected in this step 200, the method may be ended or be run through again with step 200. After a jump or a lift-off of at least one wheel has been detected, it is recorded in step 210 whether a rotary motion of the bicycle is at hand and how extensive this rotary motion is. This detection may be accomplished via the detection of an acceleration sensor that measures in at least two directions, a rotational frequency sensor, a position/tilt/state sensor or some other sensor suitable for this purpose, for instance. Conceivable is also, for example, that the sensor signals from two sensors are processed together in order to detect the rotary motion and their magnitude. For example, the use of two pressure sensors, which are mounted on the front and the rear end of the bicycle, makes it possible to derive a pressure differential that changes correspondingly in a rotation about the pitch axis in the forward or the backward direction. However, this requires that control unit 110, which evaluates these sensor signals, has information at its disposal about the installation location of the sensors in order to carry out the evaluation and derivation of the rotary motion in a proper manner. In addition, the absolute speed, the vertical acceleration and/or the lateral inclination of the bicycle may be taken into account in step 210 and also during the subsequent step 220, in order to infer the rotary motion or a looming fall.

In the subsequent step 220, the rotary motion thus detected is checked in order to ascertain on the basis of the available data situation whether a fall or a forward- or backward-directed roll-over is to be expected. For instance, this may be made dependent upon whether the rotary motion exceeds a certain critical magnitude in the form of a threshold value. In this context it is also conceivable to take the time into account during which the bicycle or at least the one wheel that is losing contact with the ground is already in the air, in order to derive the rotary motion already executed or still to be expected on that basis. If no fall or roll-over is detected or no corresponding tendency of having to expect a fall or a roll-over, then the method may be aborted or started anew with step 200. However, if a potential fall or a roll-over is detected in step 230 on the basis of the data, then it will be determined in step 230 whether a forward or backward roll-over is to be expected. This determination is able to be made on the basis of the already available sensor data or the evaluations, or as an alternative, it may be detected with the aid of a further sensor.

Depending on the determination of the direction in which the looming roll-over is taking place, suitable countermeasures may be initiated in step 240. In the event of a looming forward-directed roll-over over the handlebars, the motor may be controlled in such a way that the driven wheel that has lost contact with the ground (the rear wheel in the case of FIG. 1c) generates a counter torque with respect to the rotary motion of the bicycle. This additional torque reduces the rotary motion of the bicycle so that the angle between the driving surface and the longitudinal axis does not grow too large. The counter torque may possibly even be able to reduce an already existing excessive angle in order to ensure a safe landing. However, a corresponding drive of the wheel that has lost contact with the ground may also take place in case of a looming backward-directed roll-over in that the counter torque compensates for the rotary motion as well (see FIG. 1b).

On the other hand, if the bicycle is not equipped with an additional drive or if the drive is not available when the roll-over tendency is detected, then a brake device is able to be actuated which reduces or eliminates the rotary motion of the wheel that has lost contact with the ground. Since this also reduces the overall rotary motion of the bicycle, it is thereby possible to reduce the looming excessive angle between the ground surface and longitudinal axis of the bicycle during the landing.

If it is detected in step 250 that the bicycle has landed again after a jump, the method may be terminated or be run through again with step 200. The detection as to what extent the previously detected jump has been concluded may take place in a similar manner as the sensing or detecting of the jump in step 200. For example, it is conceivable that an acceleration sensor, a rotational frequency sensor and/or a position/tilt/state sensor detects a normal movement on the driving surface.

In principle, the actuation of the motor or the brake device may optionally take place until the bicycle has safely made contact with the ground again. To do so, it is continued with step 240 according to step 250 until a stable driving activity on the ground is detected. Alternatively, however, it could also be the case that only a brief actuation takes place in step 240, the effect of which will be examined anew after the renewed run-through of the present method.

In order to correct the jump or the airborne position, the actuation of the drive or the brake may optionally be carried out in step 240 as a function of the absolute speed, the vertical acceleration and the lateral inclination of the bicycle.

In a further exemplary embodiment, it is possible that a lever is available to the driver of the bicycle, which assists in an intentional rotation, i.e. a complete 360° rotation about the pitch axis of the bicycle. The additional generation of a torque in the same direction as the rotation of the bicycle on at least one of the wheels that is losing contact with the ground makes it possible for the rotation to be carried out more rapidly in that the generated torque is summed up with the torque generated by the jump in an additive manner. The lever may be realized as a software solution in a control of the drive.

It is pointed out that the term roll-over in the above description is meant to also describe a partial roll-over. Furthermore, it should be noted that the detection of the rotation of the bicycle about the pitch axis is not to be limited to the axis in the bicycle center but may also describe any other axis of rotation, perpendicular to the lateral surface of the bicycle. In addition, a roll-over tendency should generally be understood as the existence of a reasonable risk of the occurrence of a roll-over of the bicycle either in the forward or backward direction. The reduction of the roll-over tendency therefore entails that the risk is reduced by the intervention, e.g., by the generation of a counter torque. A complete elimination of the risk of the roll-over tendency cannot be guaranteed since it is possible, for example, that the driver, through his behavior during the jump, may contribute an additional risk potential that the method of the present invention is unable to compensate.

1.-9. (canceled)

10. A method for preventing a fall in a jump with a two-wheeler, comprising:
detecting a jump of the two-wheeler by detecting a lifting-off of at least one wheel of the two-wheeler;
detecting a roll-over tendency of the two-wheeler; and
generating a counter torque on the at least one lifting-off wheel in order to reduce the roll-over tendency.

11. The method as recited in claim 10, wherein the two-wheeler includes a bicycle.

12. The method as recited in claim 10, wherein the counter torque is generated by actuating an electric drive of the two-wheeler to generate a rotary motion of the at least one lifting-off wheel.

13. The method as recited in claim 10, wherein the counter torque is generated by reducing a rotary motion of the at least one lifting-off wheel in that an actuation of an electric drive of the two-wheeler which is acting on the at least one lifting-off wheel is one of reduced and terminated.

14. The method as recited in claim 10, wherein the counter torque is generated by actuating a brake device of the two-wheeler in order to at least reduce a rotary motion of the at least one lifting-off wheel.

15. The method as recited in claim 10, wherein at least one of the jump and the roll-over tendency is detected as a function of at least one of an acceleration signal, a pressure signal, a tilt signal, a position signal, a yaw-rate signal, and a weight signal.

16. The method as recited in claim 10, wherein the counter torque is generated as a function of an exceeding of a threshold value of the roll-over tendency.

17. The method as recited in claim 16, wherein the threshold value represents at least one of a critical tilt and a rotation about a pitch axis.

18. A device for preventing a fall in a jump with a two-wheeler, comprising:
a control unit for processing at least one sensor signal, the control unit, in response to the at least one sensor signal:
detecting a jump of the two-wheeler by detecting a lifting-off of at least one wheel of the two-wheeler;
detecting a roll-over tendency of the two-wheeler; and
generating a counter torque on the at least one lifting-off wheel in order to reduce the roll-over tendency by actuating at least one of a drive and a brake device.

19. The device as recited in claim 18, wherein the two-wheeler includes a bicycle.

20. The device as recited in claim 19, wherein the control unit detects at least one of the lifting-off of at least one of the wheels, a jump of the two-wheeler, and the roll-over tendency as a function of at least one of an acceleration variable, a pressure variable, a tilt variable, a positional variable, a yaw-rate variable, and a weight variable.

21. The device as recited in claim 18, wherein the control unit generates an actuation signal for generating the counter torque as a function of an exceeding of a threshold value of the roll-over tendency.

22. The device as recited in claim 21, wherein the threshold value represents at least one of a critical tilt and a rotation about a pitch axis.

23. The device as recited in claim 18, wherein the brake device on the wheel lifting off is activated in such a way that a torque that at least one of produces and supports a rotary motion of the two-wheeler is one of reduced and removed.
